(19) United States
(12) Patent Application Publication
(10) Pub. No.: US 2005/0214575 A1
(43) Pub. Date: Sep. 29, 2005

(54) Organic electroluminescence element

(75) Inventors: Tatsuya Igarashi, Kanagawa (JP); Toshihiro Ise, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/090,494

(22) Filed: Mar. 28, 2005

(30) Foreign Application Priority Data
Mar. 26, 2004 (JP) 2004-093811

(51) Int. Cl. H05B 33/14

(52) U.S. Cl. 428/690; 428/917; 313/504; 313/506; 257/102; 257/103

(57) ABSTRACT

An organic electroluminescence element comprising at least one organic compound layer between a pair of electrodes, wherein the organic compound layer(s) include(s) a luminescent layer; the luminescent layer comprises a fluorescent compound which emits fluorescent light upon application of voltage; the luminescent layer further comprises an amplifying agent having a function of amplifying the number of singlet excitons formed upon application of voltage thereby amplifying luminescence intensity upon application of voltage; an amount of the amplifying agent is such an amount that at least 51% of light components emitted by the element upon the application of voltage is fluorescent light; and the fluorescent compound has a substituent capable of decreasing an efficiency of Dexter energy transfer from a triplet exciton of the amplifying agent to a triplet exciton of the fluorescent compound.

### CROSS-REFERENCE TO RELATED APPLICATION

This application claims priority under 35 USC 119 from Japanese Patent Application No. 2004-93811, the disclosure of which is incorporated by reference herein.

### BACKGROUND OF THE INVENTION

1. Field of the Invention

The present invention relates to an organic electroluminescence element.

2. Description of the Related Art

Organic electroluminescence elements can give light of high luminance at low voltage, and are thus noteworthy as a promising display device. The external quantum efficiency is an important property value of this organic electroluminescence element. The external quantum efficiency is calculated according to the equation below, and the element is considered to be more advantageous with regard to energy consumption if the external quantum efficiency is higher.

External quantum efficiency φ=number of photons released from the element/number of electrons injected into the element.

The external quantum efficiency of the organic electroluminescence element is determined specifically according to the following equation:
External quantum efficiency φ=internal quantum efficiency light extraction efficiency.

In organic EL elements utilizing fluorescent emission from organic compounds, the upper limit of internal quantum efficiency is 25%. Since the light extraction efficiency is about 20%, the upper limit of external quantum efficiency is estimated to be about 5%.

For improving the external quantum efficiency of an organic electroluminescence element by improving the internal quantum efficiency of the element, an element using a triplet luminescent material (phosphorescent material) has been reported (see, for example, International publication No. WO 2000/070655). This element can achieve a higher external quantum efficiency than a conventional element (singlet luminescent element) utilizing florescent emission, and can realize a maximum external quantum efficiency of 8% (an external quantum efficiency at 100 cd/m² is 7.5%). However, since phosphorescent emission from a heavy atom metal complex is used in the element using a phosphorescent material, the emission response is slow, and there are also needs for improvement in durability.

In order to solve this problem, a singlet luminescence element using energy transfer from triplet exciton to singlet exciton has been reported (see, for example, WO 2001-008230). However, the durability of the element described in this reference is not satisfactory.

### SUMMARY OF THE INVENTION

The present invention provides a luminescence element excellent in durability of the element.

According to the invention, an organic electroluminescence element is provided which comprises at least one organic compound layer between a pair of electrodes. The organic compound layer(s) include(s) a luminescent layer. The luminescent layer comprises a fluorescent compound which emits fluorescent light upon application of voltage. The luminescent layer further comprises an amplifying agent having a function of amplifying the number of singlet excitons formed upon application of voltage thereby amplifying luminescence intensity upon application of voltage. The light emitted upon application of voltage is derived mainly from the fluorescent light emitted from the fluorescent compound. The fluorescent compound has a substituent capable of decreasing efficiency of Dexter energy transfer from a triplet exciton of the amplifying agent and/or a host material to a triplet exciton of the fluorescent compound.

The invention also provides another electroluminescence element which comprises at least one organic compound layer. The organic compound layer(s) include(s) a luminescent layer. The luminescent layer comprises a fluorescent compound which emits fluorescent light upon application of voltage. The luminescent layer further comprises an amplifying agent having a function of amplifying the number of singlet excitons formed upon application of voltage thereby amplifying luminescence intensity upon application of voltage. The light emitted upon application of voltage is derived mainly from the fluorescent light emitted from the fluorescent compound. The nucleus of the fluorescent compound is substantially three-dimensionally covered with substituents.

The invention further provides an electroluminescence element which comprises at least one organic compound layer. The organic compound layer(s) include(s) a luminescent layer. The luminescent layer comprises a fluorescent compound which emits fluorescent light upon application of voltage. The luminescent layer further comprises an amplifying agent having a function of amplifying the number of singlet excitons formed upon application of voltage thereby amplifying luminescence intensity upon application of voltage. The light emitted upon application of voltage is derived mainly from the fluorescent light emitted from the fluorescent compound. The fluorescent compound has a substituent capable of decreasing efficiency of electron transfer from adjoining molecules to the fluorescent compound.

In an embodiment, the sum of the number of tertiary carbon atoms and the number of quaternary carbon atoms in the fluorescent compound is 2 to 30. In another embodiment, the sum of the number of tertiary carbon atoms and the number of quaternary carbon atoms in the fluorescent compound is 4 to 20. In another embodiment, the sum of the number of tertiary carbon atoms and the number of quaternary carbon atoms in the fluorescent compound is 6 to 15.

In an embodiment, the number of quaternary carbon atoms in the fluorescent compound is 2 to 30. In another embodiment, the number of quaternary carbon atoms in the fluorescent compound is 4 to 20. In another embodiment, the number of quaternary carbon atoms in the fluorescent compound is 6 to 15.

In an embodiment, the number of sp³ carbon atoms in the fluorescent compound is 8 to 100. In another embodiment, the number of sp³ carbon atoms in the fluorescent compound is 17 to 70. In another embodiment, the number of Sp3 carbon atoms in the fluorescent compound is 20 to 60.

In an embodiment, the fluorescent compound is selected from the group consisting of condensed-ring aromatic compounds, distyrylarylene derivatives, oligoarylene derivatives, aromatic nitrogen-containing heterocyclic compounds, sulfur-containing heterocyclic compounds, metal complexes, oxo-substituted heterocyclic compounds, organic silicon compounds, and triarylamine derivatives.

According to the invention, a highly efficient organic electroluminescence element capable of emitting fluorescence with high durability can be obtained.

### DETAILED DESCRIPTION OF THE INVENTION

Hereinafter, an organic electroluminescence element of the present invention will be described in detail.

A first embodiment of the invention is an organic electroluminescence element comprising at least one organic compound layer between a pair of electrodes, wherein the organic compound layer(s) include(s) a luminescent layer, the luminescent layer comprises a fluorescent compound which emits fluorescent light upon application of voltage, the luminescent layer further comprises an amplifying agent having a function of amplifying the number of singlet excitons formed upon application of voltage thereby amplifying luminescence intensity upon application of voltage, the light emitted upon application of voltage is derived mainly from the fluorescent light emitted from the fluorescent compound, and the fluorescent compound has a substituent capable of decreasing efficiency of Dexter energy transfer from a triplet exciton of the amplifying agent and/or a host material to a triplet exciton of the fluorescent compound.

A second embodiment of the invention is an electroluminescence element comprising at least one organic compound layer, wherein the organic compound layer(s) include(s) a luminescent layer, the luminescent layer comprises a fluorescent compound which emits fluorescent light upon application of voltage, the luminescent layer further comprises an amplifying agent having a function of amplifying the number of singlet excitons formed upon application of voltage thereby amplifying luminescence intensity upon application of voltage, the light emitted upon application of voltage is derived mainly from the fluorescent light emitted from the fluorescent compound, and the nucleus of the fluorescent compound is substantially three-dimensionally covered with substituents.

A third embodiment of the invention is an electroluminescence element comprising at least one organic compound layer, wherein the organic compound layer(s) include(s) a luminescent layer, the luminescent layer comprises a fluorescent compound which emits fluorescent light upon application of voltage, the luminescent layer further comprises an amplifying agent having a function of amplifying the number of singlet excitons formed upon application of voltage thereby amplifying luminescence intensity upon application of voltage, the light emitted upon application of voltage is derived mainly from the fluorescent light emitted from the fluorescent compound, and the fluorescent compound has a substituent capable of decreasing efficiency of electron transfer from adjoining molecules to the fluorescent compound.

The organic electroluminescence element of the invention is an element comprising a pair of electrodes, and a luminescent layer or a plurality of organic compound layers including the luminescent layer disposed between the pair of electrodes. The organic compound layer may comprise a hole injection layer, a hole transport layer, an electron injection layer, an electron transport layer and a protective layer in addition to the luminescent layer. Each layer may have another function in addition to its main function.

The luminescent layer of the invention includes the fluorescent compound and the amplifying agent. Materials for the luminescent layer and other layers may be selected from various materials.

The term “a substituent capable of decreasing efficiency of Dexter energy transfer from a triplet exciton of the amplifying agent and/or a host material to a triplet exciton of the fluorescent compound” used herein refers to such a substituent that a compound obtained by providing the substituent on a nucleus of a fluorescent compound has a lower efficiency of Dexter energy transfer from a triplet exciton of the amplifying agent and/or a host material to a triplet exciton of the fluorescent compound than the corresponding Dexter energy transfer efficiency of the nucleus of the fluorescent compound not having the substituent.

When a triplet exciton of the amplifying agent is formed in the luminescence element containing the fluorescent compound and the amplifying agent, the energy is transferred by the following processes: one of the processes is a process in which energy is transferred from the triplet exciton of the amplifying agent to a triplet exciton of the fluorescent compound by Dexter energy transfer, the other process is a process in which energy is transferred from the triplet exciton of the amplifying agent to a singlet exciton of the fluorescent compound by Förster energy transfer. Förster energy transfer from the triplet exciton of the amplifying agent to a singlet exciton of the fluorescent compound is enhanced by decreasing the efficiency of Dexter energy transfer from the triplet exciton of the amplifying agent and/or a host material to a triplet exciton of the fluorescent compound.

It is advantageous to suppress Dexter energy transfer from a triplet exciton of the amplifying agent and/or a host material to a triplet exciton of the fluorescent compound, since formation of a non-luminescent triplet exciton of the fluorescent compound is suppressed and formation of a luminescent singlet exciton of the fluorescent compound is facilitated, whereby the efficiency of the luminescence element can be improved.

The efficiency of Dexter energy transfer from a triplet exciton of the amplifying agent to a triplet exciton of the fluorescent compound can be determined by an optical measurement of a film or solution containing the amplifying agent and fluorescent compound. The principle thereof will be briefly described below.

The amplifying agent in the film containing the amplifying agent and fluorescent compound is photo-excited to form a singlet exciton of the amplifying agent. Since the amplifying agent is usually a compound having a heavy element in the invention, the singlet exciton of the amplifying agent is promptly converted to a triplet exciton. When energy is transferred from the triplet exciton of the amplifying agent to a triplet exciton of the fluorescent compound by Dexter energy transfer, phosphorescent light emitted from the triplet exciton of the amplifying agent is quenched by the fluorescent compound, and the lifetime of the exciton of the amplifying agent is shortened. When the Dexter energy transfer occurs, fluorescent light is not emitted by the fluorescent compound since the generated exciton of the fluorescent compound is a triplet exciton.

When energy is transferred from the triplet exciton of the amplifying agent to the singlet exciton of the fluorescent compound by Förster energy transfer, the triplet exciton of the amplifying agent is quenched by the fluorescent compound, so that the lifetime of the exciton of the amplifying agent is shortened. When the Förster energy transfer occurs, fluorescent light is emitted from the fluorescent compound since the generated exciton of the fluorescent compound is a singlet exciton.

Therefore, the efficiency of Dexter energy transfer from a triplet exciton of the amplifying agent to a triplet exciton of the fluorescent compound can be obtained by: photo-exciting the amplifying agent in a film containing the amplifying agent and the fluorescent compound; and measuring the luminescence intensity of the fluorescent compound.

For example, a certain kind of substituent is considered as a substituent capable of decreasing the efficiency of Dexter energy transfer from a triplet exciton of the amplifying agent to a triplet exciton of the fluorescent compound, if a compound (A1) having a substituent or substituents of the kind exhibits a higher luminescence intensity than a compound (A2) which has the same structure as compound (A1) except that compound (A2) does not have a substituent of the kind. However, incorporation of the substituent(s) may change the quantum yield of the fluorescence of the fluorescent compound, therefore the efficiency of Dexter energy transfer may be obtained by correcting the obtained data on the basis of the change in fluorescence quantum yield.

The substituent capable of decreasing the efficiency of Dexter energy transfer from the amplifying agent to the fluorescent compound is not particularly restricted, and examples of the substituent include those represented by R¹¹ in Formula (1) described below. Preferable examples of the substituent capable of decreasing the efficiency of Dexter energy transfer include alkyl groups, aryl groups, heterocyclic groups, alkoxy groups, aryloxy groups, heterocyclyl oxy groups, silyl groups, siloxy groups, and amino groups. Alkyl groups, aryl groups, alkoxy groups, aryloxy groups, silyl groups and siloxy groups are more preferable, alkyl groups, alkoxy groups and siloxy groups are still more preferable, and alkyl groups are further more preferable.

The substituent capable of decreasing efficiency of Dexter energy transfer from the amplifying agent to the fluorescent compound is preferably a substituent having a branched chain from the viewpoint of suppressing overlap of molecular orbits. The substituent is more preferably a substituent having a tertiary or quaternary carbon atom, still more preferably a substituent having a quaternary carbon atom, and particularly preferably an alkyl group having a quaternary carbon atom. The sum of the number of tertiary carbon atoms and the number of quaternary carbon atoms in the substituent is preferably 2 to 30, more preferably 2 to 20, still more preferably 2 to 10. The number of quaternary carbon atoms in the substituent is preferably 2 to 30, more preferably 2 to 20, still more preferably 2 to 10.

The total carbon number of the substituent capable of decreasing the efficiency of Dexter energy transfer from the amplifying agent to the fluorescent compound is preferable 8 to 100, more preferably 12 to 80, further preferably 17 to 70, and particularly preferably 20 to 60, from the viewpoint of suppressing overlap of the molecular orbits.

The number of the substituents capable of decreasing efficiency of Dexter energy transfer from the amplifying agent to the fluorescent on the nucleus of the fluorescent compound is preferably 3 to 20, more preferably 4 to 15, and further preferably 5 to 10.

The expression “the nucleus of the fluorescent compound is substantially three-dimensionally covered with substituents” used herein refers to a situation in which the nucleus of the fluorescent compound is prevented from contacting an adjoining molecule by substituents on the nucleus, wherein the contact between the nucleus and the adjoining molecule refers to, for example, an interaction between a π-orbit of the nucleus and a π-orbit of an amplifying agent molecule and/or a host molecule, and the interaction refers to such an interaction by which a π-electron can be exchanged between the π-orbit of the nucleus and the π-orbit of the amplifying agent molecule and/or the host molecule.

Examples of the substituent which can three-dimensionally covers the nucleus of the fluorescent compound include the substituents described in the description of the substituent capable of decreasing the efficiency of Dexter energy transfer from a triplet exciton of the amplifying agent to a triplet exciton of the fluorescent compound. Preferable range of the substituent which can three-dimensionally covers the nucleus of the fluorescent compound is the same as the preferable range of the substituent capable of decreasing the efficiency of Dexter energy transfer described above.

For example, when branched alkyl groups are introduced into rubrene, the alkyl groups can cover the atoms of rubrene more efficiently as the number of the substituents is increased, as the number of branches is increased or as the number of the carbon atoms is increased. Whether the atoms of rubrene are substantially covered or not can be judged by measuring concentration dependency of emission spectrum. For example, it is concluded that the rubrene frame is substantially covered with substituents if the difference in emission peak wavelength between the fluorescence spectrum of a 0.001 mol % solution of an alkyl-substituted rubrene and the fluorescence spectrum of a 0.1 mol % solution of the alkyl-substituted rubrene falls within ±2 nm.

When the nucleus of the fluorescent compound is substantially three-dimensionally covered with the substituent, Dexter energy transfer from the amplifying agent to the fluorescent material tends to be suppressed; in addition, degradation of the fluorescent compound caused by interactions with adjoining molecules is suppressed.

The substituent capable of decreasing efficiency of electron transfer from adjoining molecules to the fluorescent compound is such a substituent that the efficiency of electron transfer from an adjoining molecule (such as a host material or the amplifying agent) to a fluorescent compound is higher than the efficiency of electron transfer from the adjoining molecule to a compound obtained by incorporating the substituent into the nucleus of the fluorescent compound.

Examples of the substituent capable of lowering the efficiency of electron transfer from adjoining molecules to the fluorescent compound include the substituents described above as substituents capable of decreasing the efficiency of Dexter energy transfer from a triplet exciton of the amplifying agent to a triplet exciton of the fluorescent compound. Preferable range of the substituent capable of lowering the efficiency of electron transfer from adjoining molecules to the fluorescent compound is the same as the preferable range of the substituent capable of decreasing the efficiency of Dexter energy transfer described above.

Charge recombination efficiency in the fluorescent compound decreases when electron transfer efficiency from adjoining molecules to the fluorescent compound is lowered, thereby decreasing the efficiency of forming a triplet exciton of the fluorescent compound. The decrease in efficiency of forming a non-luminescent triplet exciton of the fluorescent compound is preferable since the efficiency of the electroluminescence element is improved.

The electron transfer to the fluorescent compound can be observed, for example, by determining the amount of generated radical ions of the fluorescent compound in the electroluminescence element by absorption spectrum, ESR, or the like.

In the organic electroluminescence element of the invention, the light emitted upon application of voltage is derived mainly from light emitted by the fluorescent compound. In other words, 51% or more of the emission components obtained from the element are luminescence (fluorescence) from singlet excitons, and the remainder (49% or less) are luminescence (phosphorescence) from triplet excitons. In a preferable embodiment, 70% or more of the emission components obtained from the element are fluorescence and 30% or less of the emission components are phosphorescence. In a more preferable embodiment, 80% or more of the emission components obtained from the element are fluorescence and 20% or less of the emission components are phosphorescence. In a still more preferable embodiment, 90% or more of the emission components obtained from the element are fluorescence and 10% or less of the emission components are phosphorescence. It is preferable that the luminescence is mainly derived from fluorescence, because the response and durability of luminescence are higher than in a case where phosphorescence is the main component, and decrease in efficiency at the time of high luminance (for example 1000 cd/m² or higher) is smaller than in a case where phosphorescence is the main component.

The phosphorescence peak wavelength of the amplifying agent is preferably 380 nm to 650 nm, more preferably 400 nm to 630 nm, further preferably 410 nm to 620 nm, and particularly preferably 420 nm to 610 nm.

The phosphorescence spectrum of the amplifying agent preferably has a phosphorescence peak wavelength in the above range. The amplifying agent is preferably an amplifying agent whose phosphorescence spectrum overlaps the absorption spectrum of the fluorescent compound at least partially, from the viewpoint of facilitating Förster excitation energy transfer.

Phosphorescence of the amplifying agent may be determined, for example by: freeze-degassing a solution containing the amplifying agent (for example 1×10⁻⁵ mol/l solution in toluene), exciting the amplifying agent with a light of its absorption peak at 20° C., and measuring the phosphorescence.

The lifetime of phosphorescence of the amplifying agent is preferably 10 μs or shorter, more preferably 7 μs or shorter, and particularly preferably 5 μs or shorter.

The phosphorescence quantum yield of the amplifying agent used in the invention is preferably 20% or higher, more preferably 40% or higher, still more preferably 60% or higher. The phosphorescence quantum yield of the amplifying agent can be measured at 20° C. after freeze-degassing a solution containing the amplifying agent (for example 1×10⁻⁵ mol/l solution in toluene).

The emission peak of the fluorescent compound used in the invention is preferably 350 nm to 680 nm, more preferably 410 nm to 670 nm, still more preferably 420 nm to 660 nm, further more preferably 430 nm to 650 nm.

The organic EL element of the invention preferably comprises at least one host material in the luminescent layers. The host material may be contained in the fluorescent-compound-containing layer, which is one of the luminescent layers, or may be contained in the amplifying-agent-containing layer. The host material is contained preferably in both the fluorescent-compound-containing layer and the amplifying-agent-containing layer.

The T₁ level (energy level of the minimum excited triplet state) of the host material used in the luminescence element of the invention is preferably 209.2 kJ/mol (50 kcal/mol) to 377.1 kJ/mol (90 kcal/mol), more preferably 217.6 kJ/mol (52 kcal/mol) to 335.2 kJ/mol (80 kcal/mol), still more preferably 230.1 kJ/mol (55 kcal/mol) to 293.3 kJ/mol (70 kcal/mol).

The T₁ level (energy level of the lowest excited triplet state) of the layer (for example, an electron transport layer, a hole block layer, or an exciton block layer) contacting the cathode-side surface of the luminescent layer in the luminescence element of the invention is preferably 209.2 kJ/mol (50 kcal/mol) to 377.1 kJ/mol (90 kcal/mol), more preferably 217.6 kJ/mol (52 kcal/mol) to 335.2 kJ/mol (80 kcal/mol), still more preferably 230.1 kJ/mol (55 kcal/mol) to 293.3 kJ/mol (70 kcal/mol).

The T₁ level (energy level of the lowest excited triplet state) of the layer (for example, a hole transport layer) contacting the anode-side surface of the luminescent layer is preferably 209.2 kJ/mol (50 kcal/mol) to 377.1 kJ/mol (90 kcal/mol), more preferably 217.6 kJ/mol (52 kcal/mol) to 335.2 kJ/mol (80 kcal/mol), still more preferably 230.1 kJ/mol (55 kcal/mol) to 293.3 kJ/mol (70 kcal/mol).

In the invention, the fluorescent compound is preferably a compound represented by the following Formula (1), more preferably a compound represented by the following Formula (2), and further preferably a compound represented by the following Formula (3).

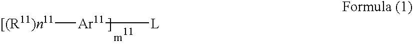

In Formula (1), Ar¹¹ represents an aryl group or a heteroaryl group, R¹¹ represents a substituent, n¹¹ represents an integer of 1 or larger, m¹¹ represents an integer of 2 or larger, and L represents a linking group or a single bond.

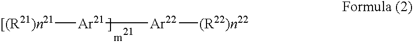

In Formula (2), Ar²¹ represents an aryl group or a heteroaryl group, Ar²² represents an aryl linking group or a heteroaryl linking group, R²¹ and R²² each independently represent a substituent, n²¹ represents an integer of 1 or larger, n²² represents an integer of 0 or larger, and m²¹ represents an integer of 2 or larger.

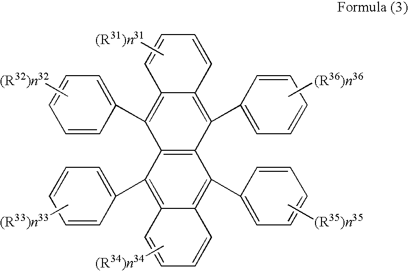

In Formula (3), R³¹ to R³⁶ each independently represent a substituent. Examples of each substituent include those described as examples of the group represented by R¹¹.

Formula (1) will be described in detail.

Ar¹¹ represents an aryl group or a heteroaryl group, preferably an aryl group.

When Ar¹¹ represents an aryl group, examples thereof include a phenyl group, a naphthyl group, an anthryl group, a phenanthyl group, a pyrenyl group, a perylenyl group and a triphenylenyl group. A phenyl group, a naphthyl group, an anthryl group and a pyrenyl group are preferable, and a pyrenyl group and a naphthyl group are more preferable. A phenyl group is still more preferable.

When Ar¹¹ represents a heteroaryl group, examples thereof include a pyridyl group, a pyrazyl group, a pyrimidyl group, a triazyl group, an imidazolyl group, a pyrazolyl group, an oxazolyl group, a benzoimidazolyl group, a benzoxazolyl group and an oxadiazoyl group. A pyridyl group, a pyrazyl group, a benzoimidazolyl group and a benzoxazolyl group are preferable, a pyridyl group and a benzoimidazolyl group are more preferable, and pyridyl group is further preferable.

R¹¹ represents a substituent. The substituent may be, for example: an alkyl group (preferably having 1 to 30 carbon atoms, more preferably having 1 to 20 carbon atoms, particularly preferably having 1 to 10 carbon atoms, such as methyl, ethyl, iso-propyl, tert-butyl, n-octyl, n-decyl, n-hexadecyl, cyclopropyl, cyclopentyl, or cyclohexyl); an alkenyl group (preferably having 2 to 30 carbon atoms, more preferably having 2 to 20 carbon atoms, particularly preferably having 2 to 10 carbon atoms, such as vinyl, allyl, 2-butenyl, or 3-pentenyl); an alkynyl group (preferably having 2 to 30 carbon atoms, more preferably having 2 to 20 carbon atoms, particularly preferably having 2 to 10 carbon atoms, such as propargyl or 3-pentynyl); an aryl group (preferably having 6 to 30 carbon atoms, more preferably having 6 to 20 carbon atoms, particularly preferably having 6 to 12 carbon atoms, such as phenyl, p-methylphenyl, naphthyl, or anthranyl); an amino group (whose carbon number is preferably 0 to 30, more preferably 0 to 20, particularly preferably 0 to 10, such as amino, methylamino, dimethylamino, diethylamino, dibenzylamino, diphenylamino, or ditolylamino);
an alkoxy group (preferably having 1 to 30 carbon atoms, more preferably having 1 to 20 carbon atoms, particularly preferably having 1 to 10 carbon atoms, such as methoxy, ethoxy, butoxy, or 2-ethylhexyloxy); an aryloxy group (preferably having 6 to 30 carbon atoms, more preferably having 6 to 20 carbon atoms, particularly preferably having 6 to 12 carbon atoms, such as phenyloxy, 1-naphthyloxy, or 2-naphthyloxy); a heterocyclyl oxy group (preferably having 1 to 30 carbon atoms, more preferably having 1 to 20 carbon atoms, particularly preferably having 1 to 12 carbon atoms, such as pyridyloxy, pyrazyloxy, pyrimidyloxy, or quinolyloxy); an acyl group (preferably having 1 to 30 carbon atoms, more preferably having 1 to 20 carbon atoms, particularly preferably having 1 to 12 carbon atoms, such as acetyl, benzoyl, formyl, or pivaloyl);
an alkoxycarbonyl group (preferably having 2 to 30 carbon atoms, more preferably having 2 to 20 carbon atoms, particularly preferably having 2 to 12 carbon atoms, such as methoxycarbonyl or ethoxycarbonyl); an aryloxycarbonyl group (preferably having 7 to 30 carbon atoms, more preferably 7 to 20 carbon atoms, particularly preferably having 7 to 12 carbon atoms such as phenyloxycarbonyl); an acyloxy group (preferably having 2 to 30 carbon atoms, more preferably having 2 to 20 carbon atoms, particularly preferably having 2 to 10 carbon atoms, such as acetoxy or benzoyloxy); an acylamino group (preferably having 2 to 30 carbon atoms, more preferably having 2 to 20 carbon atoms, particularly preferably having 2 to 10 carbon atoms, such as acetylamino or benzoylamino); an alkoxycarbonylamino group (preferably having 2 to 30 carbon atoms, more preferably having 2 to 20 carbon atoms, particularly preferably having 2 to 12 carbon atoms, such as methoxycarbonylamino);
an aryloxycarbonylamino group (preferably having 7 to 30 carbon atoms, more preferably having 7 to 20 carbon atoms, particularly preferably having 7 to 12 carbon atoms, such as phenyloxycarbonylamino); a sulfonylamino group (preferably having 1 to 30 carbon atoms, more preferably having 1 to 20 carbon atoms, particularly preferably having 1 to 12 carbon atoms, such as methanesulfonylamino or benzenesulfonylamino); a sulfamoyl group (whose carbon number is preferably 0 to 30, more preferably 0 to 20, particularly preferably 0 to 12, such as sulfamoyl, methylsulfamoyl, dimethylsulfamoyl, or phenylsulfamoyl); a carbamoyl group (preferably having 1 to 30 carbon atoms, more preferably having 1 to 20 carbon atoms, particularly preferably having 1 to 12 carbon atoms, such as carbamoyl, methylcarbamoyl, diethylcarbamoyl, or phenylcarbamoyl); an alkylthio group (preferably having 1 to 30 carbon atoms, more preferably having 1 to 20 carbon atoms, particularly preferably 1 to 12 carbon atoms, such as methylthio or ethylthio);
an arylthio group (preferably having 6 to 30 carbon atoms, more preferably 6 to 20 carbon atoms, particularly preferably 6 to 12 carbon atoms, such as phenylthio); a heterocyclic thio group (preferably having 1 to 30 carbon atoms, more preferably having 1 to 20 carbon atoms, particularly preferably having 1 to 12 carbon atoms, such as pyridylthio, 2-benzimizolylthio, 2-benzoxazolylthio, or 2-benzthiazolylthio); a sulfonyl group (preferably having 1 to 30 carbon atoms, more preferably having 1 to 20 carbon atoms, particularly preferably having 1 to 12 carbon atoms, such as mesyl or tosyl); a sulfinyl group (preferably having 1 to 30 carbon atoms, more preferably having 1 to 20 carbon atoms, particularly preferably having 1 to 12 carbon atoms, such as methanesulfinyl or benzenesulfinyl); an ureido group (preferably having 1 to 30 carbon atoms, more preferably having 1 to 20 carbon atoms, particularly preferably having 1 to 12 carbon atoms, such as ureido, methylureido, or phenylureido); a phosphoric amide group (preferably having 1 to 30 carbon atoms, more preferably having 1 to 20 carbon atoms, particularly preferably having 1 to 12 carbon atoms, such as diethylphosphoric amide or phenylphosphoric amide); a hydroxy group;
a mercapto group; a halogen atom (such as a fluorine atom, a chlorine atom, a bromine atom, or an iodine atom); a cyano group; a sulfo group; a carboxyl group; a nitro group; a hydroxamic acid group; a sulfino group; a hydrazino group; an imino group; a heterocyclic group (preferably having 1 to 30 carbon atoms, more preferably having 1 to 12 carbon atoms, the heteroatom being, for example, a nitrogen atom, an oxygen atom or a sulfur atom, specific examples of the heterocyclic group being imidazolyl, pyridyl, quinolyl, furyl, thienyl, piperidyl, morpholino, benzoxazolyl, benzimidazolyl, benzthiazolyl, carbazolyl, or azepinyl); a silyl group (preferably having 3 to 40 carbon atoms, more preferably having 3 to 30 carbon atoms, particularly preferably having 3 to 24 carbon atoms, such as trimethylsilyl or triphenylsilyl); or a silyloxy group (preferably having 3 to 40 carbon atoms, more preferably having 3 to 30 carbon atoms, particularly preferably having 3 to 24 carbon atoms, such as trimethylsilyloxy or triphenylsilyloxy). These substituents each may further have a substituent.

At least one of the groups represented by R¹¹ is a substituent capable of decreasing the efficiency of Dexter energy transfer from the amplifying agent to the fluorescent compound, a substituent which can substantially three-dimensionally covers the nucleus of the fluorescent compound, or a substituent capable of decreasing the efficiency of electron transfer from the amplifying agent to the fluorescent compound.

R¹¹ is preferably an alkyl group, an aryl group, a heterocyclic group, an alkoxy group, an aryloxy group, a heterocyclyl oxy group, a silyl group, a siloxy group or an amino group; more preferably an alkyl group, an aryl group, an alkoxy group, an aryloxy group, a silyl group or a siloxy group; further preferably an alkyl group, an alkoxy group or siloxy group; and particularly preferably an alkyl group.

R¹¹ is preferably a group having a branched chain, more preferably a group having a tertiary carbon atom and/or a quaternary carbon atom, further preferably a group having a quaternary carbon atom, particularly preferably an alkyl group having a quaternary carbon atom. The sum of the number of tertiary carbon atoms and the number of quaternary carbon atoms in the substituent capable of decreasing the efficiency of Dexter energy transfer from the amplifying agent to the fluorescent compound is preferably 2 to 10. In a preferable embodiment, the number of quaternary carbon atoms in the substituent is 2 to 10.

The total carbon number of the substituent capable of decreasing the efficiency of Dexter energy transfer from the amplifying agent to the fluorescent compound is preferable 8 to 100, more preferably 12 to 80, further preferably 17 to 70, and particularly preferably 20 to 60.

The number of the substituents capable of decreasing efficiency of Dexter energy transfer from the amplifying agent to the fluorescent on the nucleus of the fluorescent compound is preferably 3 to 20; more preferably 4 to 15, and further preferably 5 to 10.

n¹¹ represents an integer of 1 or larger. The plural groups represented by R¹¹ may be the same as each other or different from each other when n¹¹ is 2 or larger. n¹¹ is preferably in the range of 1 to 4, more preferably in the range of 1 to 3, and further preferably 1 or 2.

L represents a linking group or a single bond. The linking group may be further substituted with a substituent or substituents. The linking group is not particularly restricted. The linking group is preferably an aryl linking group, a heteroaryl linking group, an alkyl linking group, an amino linking group or a silicon linking group, more preferably an aryl linking group or a heteroaryl linking group, further preferably an aryl linking group. The aryl linking group is preferably a condensed ring aryl linking group having three of more rings (such as an anthracene linking group, a tetracene linking group, a pentacene linking group, a phenanthrene linking group, a pyrene linking group or a perylene linking group).

m¹¹ represents an integer of 2 or larger. m¹¹ is preferably 2 to 10, more preferably 3 to 8, and further preferably 4 to 6.

Formula (2) will be described in detail.

The definition of Ar²¹ is the same as the definition of Ar¹¹, and preferable range of the group represented by Ar²¹ is the same as the preferable range of the group represented by Ar¹¹.

Ar²² represents an aryl linking group or a heteroaryl linking group. Ar²² is preferably an aryl linking group, and particularly preferably a condensed ring aryl linking group having three or more rings (such as an anthracene linking group, a tetracene linking group, a pentacene linking group, a phenanthrene linking group, a pyrene linking group or a perylene linking group).

R²¹ and R²² each independently represent a substituent. Examples of the substituent represented by each of R²¹ and R²² are the same as the examples of the group represented by R¹¹ described above, and preferable range of the substituent represented by each of R²¹ and R²² is the same as the preferable range of the group represented by R¹¹ described above.

n²¹ has the same definition as the definition of n¹¹, and the preferable range of the number represented by n²¹ is the same as the preferable range of the number represented by n¹¹. n²² represents an integer of 0 or larger, preferably 0 to 10, more preferably 0 to 8, and particularly preferably 2 to 6. The plural groups represented by R²² may be the same as each other or different from each other when n²² is 2 or larger.

Formula (3) will be described in detail.

R³¹ to R³⁶ each independently represent a substituent. Examples of the substituent represented by each of R³¹ to R³⁶ are the same as the examples of the group represented by R¹¹, and the preferable range of the substituent represented by each of R³¹ to R³⁶ is the same as the preferable range of the group represented by R¹¹.

n³¹ and n³⁴ each independently represent an integer of 0 to 4, preferably 1 or 2, more preferably 1.

n³², n³³, n³⁵ and n³⁶ each independently represent an integer of 0 to 5, preferably 1, 2 or 3, more preferably 1 or 2, still more preferably 1.

The concentration of the fluorescent compound in the luminescent layer is preferably 0.1% by mass to 20% by mass, more preferably 0.2% by mass to 15% by mass, particularly preferably 0.5% by mass to 10% by mass, relative to the total mass of the luminescent layer, from the viewpoint of emission efficiency.

The luminescent layer may include only a single kind of fluorescent compound or may include two or more kinds of fluorescent compounds. The fluorescent compounds may emit lights of different colors so that, for example, a white light may be emitted by the element.

The amplifying agent used in the invention refers to a compound having a function of amplifying the number of singlet excitons formed upon application of voltage thereby amplifying the luminescence intensity of the fluorescent light emitted by the fluorescent compound upon application of voltage. The amplifying agent is not particularly limited insofar as it is a compound which is capable of amplifying the number of singlet excitons formed upon application of voltage. Examples of the amplifying agent include a compound having a function of causing energy transition from triplet excitons formed in the luminescence element to singlet excitons of the fluorescent compound or of the host material. The compound having this function may be, for example, a compound emitting phosphorescent light at 0 to 50° C. such as a transition metal complex, or a rare-earth element.

The amplifying agent is preferably an iridium complex, a platinum complex, a rhenium complex, a ruthenium complex, a palladium complex, a rhodium complex, a copper complex or a rare-earth complex, more preferably an iridium complex or a platinum complex.

Examples of the transition metal complex usable in the invention are described, for example, in Japanese Patent Application Laid-Open (JP-A) Nos. 2001-181617, 2001-247859, 2001-345183, 2002-117078, 2002-170684, 2002-173674, 2002-235076, 2002-241751; 2002-302671, 2003-123982 and 2003-133074, the disclosures of which are incorporated herein by reference.

The organic electroluminescence element of the invention preferably comprises an electron transport layer, and the electron transport layer preferably comprises a non-complex compound. The non-complex compound is not particularly limited, but is preferably a nitrogen-containing heterocyclic compound.

The nitrogen-containing heterocyclic compound is not particularly limited, but is preferably a 6-membered nitrogen-containing aromatic heterocyclic compound or a 5-membered nitrogen-containing aromatic heterocyclic compound, more preferably pyridine, pyrazine, pyrimidine, triazine, quinoxaline, quinoline, pyrrole, pyrazole, imidazole, oxazole, thiazole, oxadiazole, thiadiazole, or a derivative thereof (for example, tetraphenyl pyridine, benzimidazole, or imidazopyridine), still more preferably an imidazole derivative or an imidazopiridine derivative, further more preferably an imidazopyridine derivative.

The external quantum efficiency of the organic electroluminescence element of the invention is preferably 5% or higher, more preferably 10% or higher, still more preferably 13% or higher, from the viewpoint of reducing the electric power consumption and improving the driving durability. As the external quantum efficiency, the maximum external quantum efficiency upon driving the element at 20° C. or an external quantum efficiency at around 100 to 300 cd/m² upon driving the element at 20° C., can be used.

The internal quantum efficiency of the organic electroluminescence element of the invention is preferably 30% or higher, more preferably 50% or higher, still more preferably 70% or higher, from the viewpoint of the electric power consumption and the durability. The internal quantum efficiency of the element is calculated according to the equation: internal quantum efficiency=external quantum efficiency/light extraction efficiency. In a usual organic EL element, the light extraction efficiency is about 20%, but the light extraction efficiency can be increased to 20% or higher by devising the shape of the substrate, the shape of electrodes, the thickness of the organic layers, the thickness of the inorganic layers, the refractive index of the organic layers, the refractive index of the inorganic layers, etc. The light extraction efficiency is calculated by a formula: light extraction efficiency=½n², wherein n is the refractive index of the luminescent layer.

The concentration of the amplifying agent in the luminescent layer is not particularly restricted, and is preferably 0.1% by mass to 9% by mass, more preferably 1% by mass to 8% by mass, still more preferably 3% by mass to 6% by mass, and particularly preferably 3% by mass to 6% by mass, based on the total mass of the luminescent layer. The concentration in this range is preferable for improving efficiency and durability of the luminescence element.

Fluorescence quantum yield of the fluorescent compound of the invention is preferably 70% or higher, more preferably 80% or higher, further preferably 90% or higher, particularly preferably 95% or higher. The fluorescence quantum yield is represented by a formula: fluorescence quantum yield (%)=[(number of photons emitted as fluorescent light)/(number of photons absorbed)]×100. Fluorescence quantum yield measured in a solid film or in a solution at 20° C. may be used. For example, the fluorescence quantum yield of a fluorescent compound can be determined by comparing the luminescent intensity of the fluorescent compound with the luminescent intensity of a substance whose fluorescence quantum yield is known. Such a substance may be fluorescein, anthracene or rhodamine.

In the invention, the fluorescence quantum yield refers to the fluorescence quantum yield determined by measurements of absorption spectrum and emission spectrum of the fluorescent compound in a solution.

In a preferable embodiment, the organic electroluminescence element of the invention has at least 3 layers including a hole transport layer, a luminescent layer and an electron transport layer. In another preferable embodiment, the organic electroluminescence element of the invention has at least 3 layers including a hole transport layer, a luminescent layer and an electron transport layer, and the element does not have a hole block layer or an exciton block layer between the luminescent layer and the electron transport layer. The constitution of the organic electroluminescence element of the invention is preferably a constitution in which: there is only one electron transport layer between the luminescent layer and the electrode and no other layers exist between the luminescent layer and the electrode.

The hole block layer has a function of blocking holes injected through an anode, and the exciton block layer has a function of blocking excitons formed in the luminescent layer so as to limit the luminescence area.

The ionization potential of the host material contained in the luminescent layer of the invention is preferably 5.8 eV to 6.3 eV, more preferably 5.95 eV to 6.25 eV, still more preferably 6.0 eV to 6.2 eV, from the viewpoint of the driving voltage and efficiency.

The mobility of electrons in the host material in the luminescent layer is preferably 1×10⁻⁶ cm²/Vs to 1×10⁻¹ cm²/Vs, more preferably 5×10⁻⁶ cm²/Vs to 1×10⁻² cm²/Vs, still more preferably 1×10⁵ cm²/Vs to 1×10⁻² cm²/Vs, further more preferably 5×10⁻⁵ cm²/Vs to 1×10⁻² cm²/Vs, from the viewpoint of the driving voltage and efficiency.

The mobility of holes in the host material in the luminescent layer is preferably 1×10⁻⁶ cm²/Vs to 1×10⁻¹ cm²/Vs, more preferably 5×10⁻⁶ cm²/Vs to 1×10⁻² cm²/Vs, still more preferably 1×10⁻⁵ cm²/Vs to 1×10⁻² cm²/Vs, further more preferably 5×10⁻⁵ cm²/Vs to 1×10⁻² cm²/Vs, from the viewpoint of the driving voltage and efficiency.

The glass transition point of the host material contained in the luminescent layer of the invention, the glass transition point of the electron transport layer, and the glass transition point of the hole transport material are preferably 90 to 400° C., more preferably 100 to 380° C., still more preferably 120 to 370° C., further more preferably 140 to 360° C., from the viewpoint of the heat resistance.

The luminescence element of the invention preferably comprises a hole transport layer, a luminescent layer and an electron transport layer. In the following, layers including a fluorescent compound is ocassionally represented by “layers A1”, and layers including an amplifying agent is represented by “layers B1.” The luminescent layer preferably comprises a laminated construction comprising at least two layers in total of alternate layers A1 and B1, more preferably comprises a laminated construction comprising at least four layers in total of alternate layers A1 and B1, further preferably comprises a laminated construction comprising at least twelve layers in total of alternate layers A1 and B1, still further preferably comprises a laminated construction comprising at least sixteen layers in total of alternate layers A1 and B1.

In the case of a luminescence element comprising an alternate-lamination film according to the invention, the alternate-lamination film is formed preferably by a process comprising alternate repetition of: (a) vapor-depositing a fluorescent compound or a mixture including a fluorescent compound while blocking the vapor-deposition of an amplifying agent or a mixture including an amplifying agent with a shutter disposed in the vicinity of a vapor-deposition source so as to prevent the amplifying agent or the mixture including the amplifying agent from being vapor-deposited onto the element under production; and (b) vapor-depositing the amplifying agent or the mixture including the amplifying agent while blocking the vapor-deposition of the fluorescent compound or the mixture including the fluorescent compound with a shutter disposed in the vicinity of the vapor-deposition source so as to prevent the fluorescent compound or the mixture including the fluorescent compound from being vapor-deposited onto the element under production. Switching of the respective steps is conducted by opening and closing the shutters disposed in the vicinity of the vapor-deposition source. The process (a) may be conducted first or the process (b) may be conducted first. This process corresponds, for example, to the process described in Example 1.

In an embodiment, the luminescent layer of the invention has a multi-layer structure as described above, and layers in the multi-layer structure emit lights of different colors, so that overlap of the lights give white color whereby the luminescent layer can emit white light.

The fluorescent compound or the amplifying agent used in the invention may be a low-molecular compound, an oligomer compound, or a polymer compound. The weight-average molecular weight (polystyrene-equivalent molecular weight) of the polymer compound is preferably in the range of 1,000 to 5,000,000, more preferably 2,000 to 1,000,000, still more preferably 3,000 to 100,000. In the invention, the fluorescent compound or the amplifying agent is preferably a low-molecular compound.

While examples of the fluorescent compounds in the invention (exemplary compounds (1-1) to (1-21)) are shown below, the invention is not restricted to these compounds.

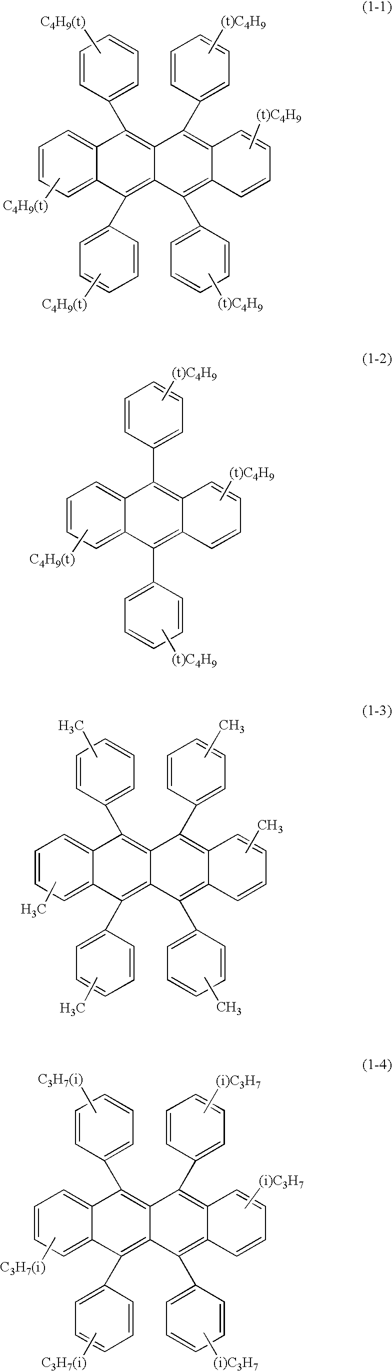

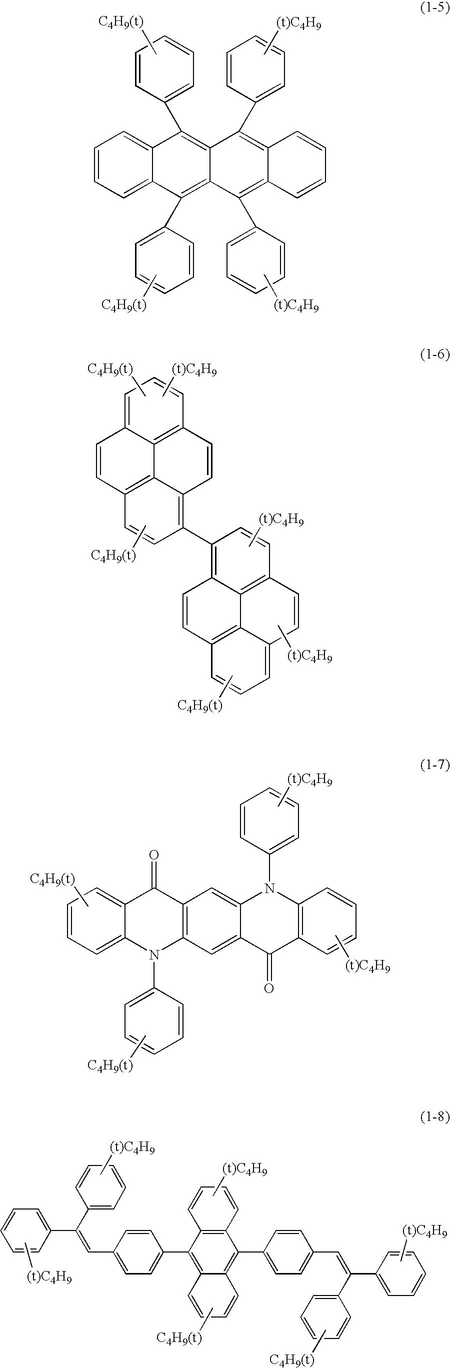

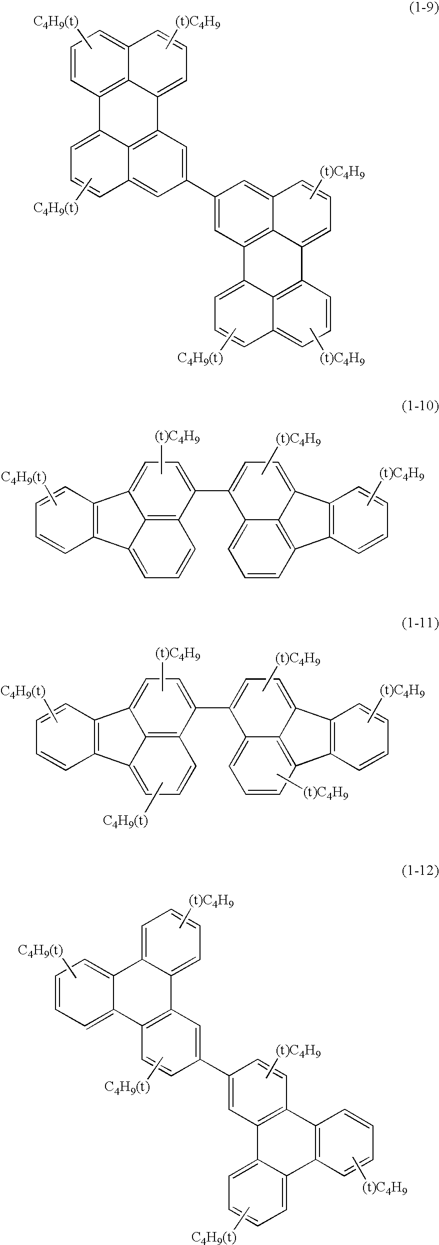

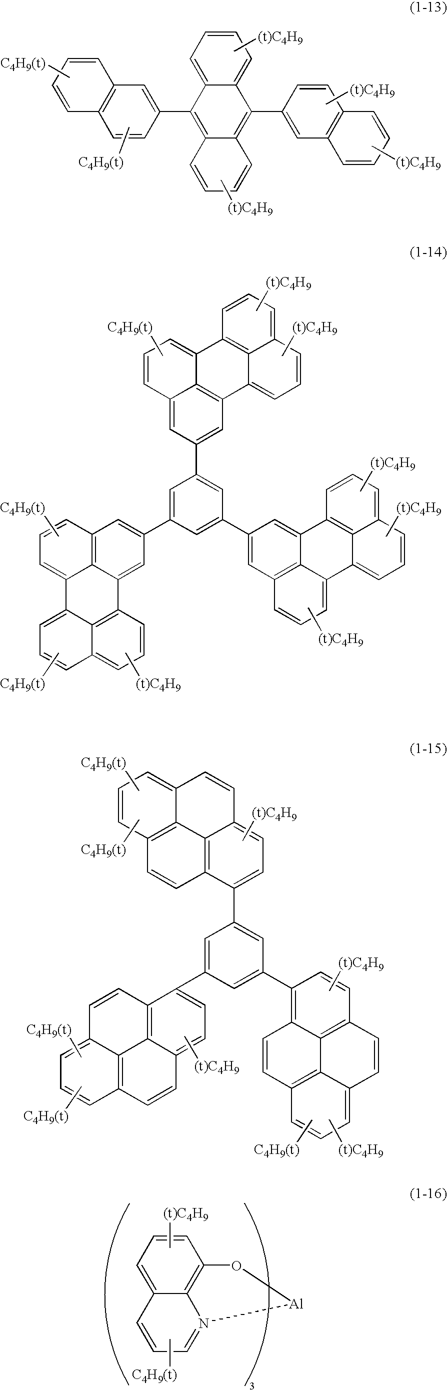

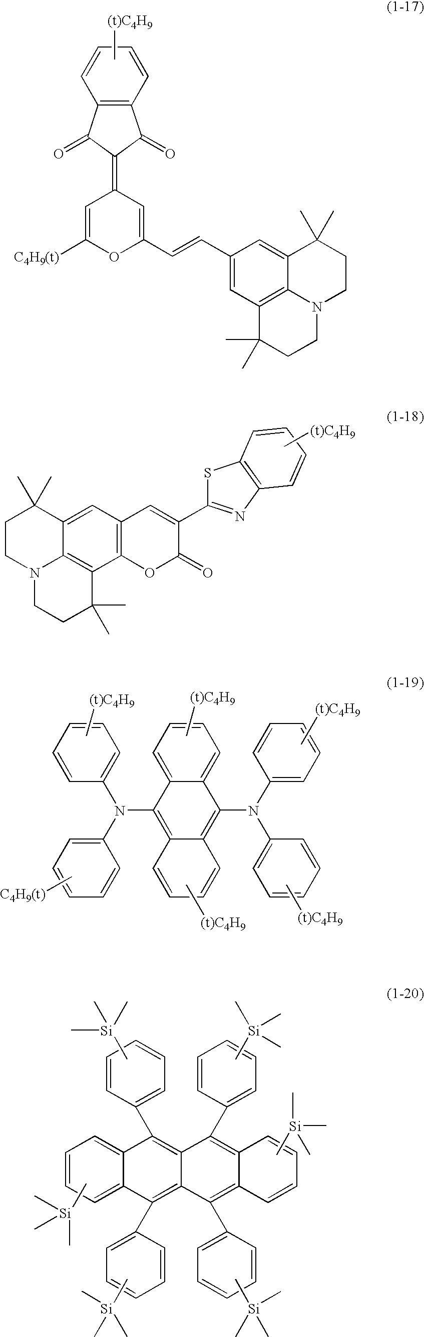

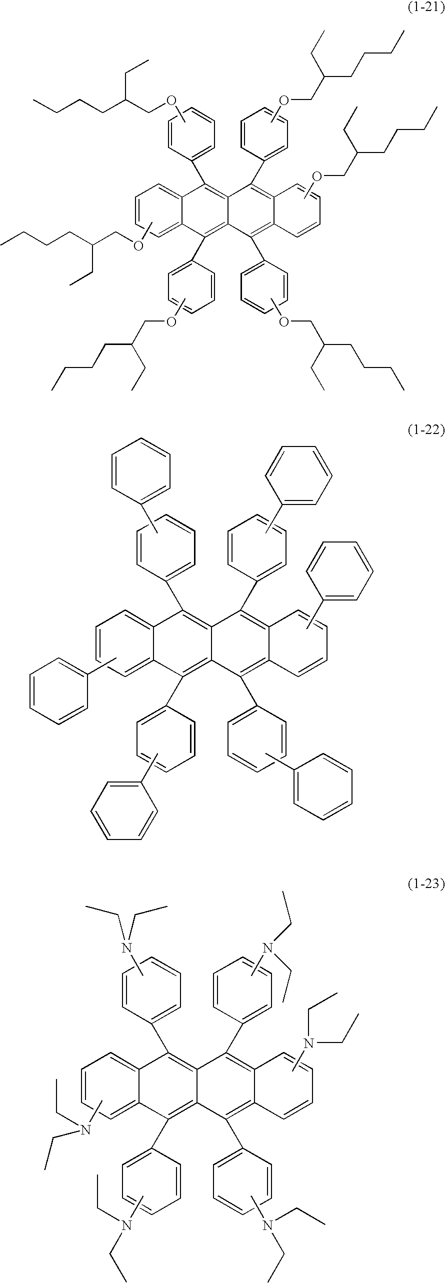

Then, the luminescence element of the invention is described. The organic electroluminescence element of the invention is not particularly limited with respect to the system, driving method, application mode etc. The luminescent element is typically an EL (electroluminescence) device.

The light extraction efficiency of the organic electroluminescence element of the invention can be improved by a wide variety of known techniques. The light extraction efficiency and the external quantum efficiency can be improved, for example by devising the surface of the substrate (for example by forming a patterned indented surface), by regulating the refractive indexes of the substrate, ITO layer, and organic layer, or by regulating the thicknesses of the substrate, ITO layer, organic layer.

The organic electroluminescence element of the invention may be a top-emission type element in which luminescent light is drawn from the anode side (disclosed, for example, in JP-A Nos. 2003-208109, 2003-248441, 2003-257651, and 2003-282261, the disclosures of which are incorporated herein by reference).

The base material used in the organic electroluminescence element of the invention is not particularly limited, and may be: an inorganic material such as zirconia stabilized with yttrium, or glass; a polyester such as polyethylene terephthalate, polybutylene terephthalate, or polyethylene naphthalate; or a polymer materials such as polyethylene, polycarbonate, polyether sulfone, polyarylate, allyl diglycol carbonate, polyimide, polycycloolefin, norbornene resin, poly(chlorotrifluoroethylene), TEFLON, or a polytetrafluoroethylene-polyethylene copolymer.

The organic electroluminescence element of the invention may contain a blue fluorescent compound. In an embodiment, a multicolor emission element or a full-color emission element is manufactured by using a combination of a blue emission element containing a blue fluorescent compound and the luminescence element of the invention.

The luminescent layer in the organic electroluminescence element of the invention may comprise at least one laminated structure. The number of laminated layers is preferably 2 to 50, more preferably 4 to 30, still more preferably 6 to 20.

The thickness of each layer constituting the laminate is not particularly limited, but is preferably 0.2 nm to 20 nm, more preferably 0.4 nm to 15 nm, still more preferably 0.5 nm to 10 nm, further more preferably 1 nm to 5 nm.

The luminescent layer in the organic electroluminescence element of the invention may comprise a plurality of domain structures. The luminescent layer may comprise other domain structures. In an exemplary embodiment, the luminescent layer comprise a 1 nm³ portion made of a mixture of a host material A and a fluorescent substance B and another 1 nm³ portion made of a mixture of a host material C and a fluorescent substance D. The diameter of each domain is preferably 0.2 nm to 10 nm, more preferably 0.3 nm to 5 nm, still more preferably 0.5 nm to 3 nm, further more preferably 0.7 nm to 2 nm.

The method of forming the organic compound layer(s) containing the specific fluorescent compound according to the invention is not particularly limited. The organic layer may be formed by resistance heating deposition, by electron beam, by sputtering, by a molecular accumulation method, by a coating method (spray coating method, dip coating method, dipping method, roll coating method, gravure coating method, reverse coating method, roll brush method, air knife coating method, curtain coating method, spin coating method, flow coating method, bar coating method, micro-gravure coating method, air doctor coating, blade coating method, squeeze coating method, transfer roll coating method, kiss coating method, cast coating method, extrusion coating method, wire bar coating method, screen coating method etc.), by an ink-jet method, by a printing method, by an LB method, or by a transfer method, among which resistance heating deposition, a coating method and a transfer method are preferable in terms of characteristics and productivity.

The organic electroluminescence element of the invention comprises a luminescent layer or a plurality of organic compound films including a luminescent layer between two electrodes (an anode and a cathode). The organic electroluminescence element of the invention may further comprise a hole injection layer, a hole transport layer, an electron injection layer, an electron transport layer, or a protective layer, in addition to the luminescent layer. Each of these layers may have functions other than its primary function. Various materials can be used to form each of the layers.

The anode supplies holes to the hole injection layer, the hole transport layer, the luminescent layer, or the like. The anode material may be an alloy, a metal oxide, an electroconductive substance or a mixture thereof, preferably a material having a work function of 4 eV or higher. Specific examples of the anode material include: electroconductive metal oxides such as tin oxide, zinc oxide, indium oxide, and indium tin oxide (ITO); metals such as gold, silver, chrome, and nickel; mixtures or laminates of any of the above metals and any of the above electroconductive metal oxides; inorganic electroconductive substances such as copper iodide and copper sulfide; organic electroconductive materials such as polyaniline, polythiophene, and polypyrrole; and laminates of ITO and any of the above materials. The anode material is preferably an electroconductive metal oxide, and ITO is particularly preferable in respect of productivity, high electric conductivity, transparency, or the like. The thickness of the anode can be suitably selected depending on its material, and usually the thickness is preferably in the range of 10 nm to 5 μm, more preferably 50 nm to 1 μm, still more preferably 100 nm to 500 nm, from the viewpoint of the driving voltage.

The anode usually has a constitution in which an anode-material layer is formed on soda lime glass, non-alkali glass, a transparent resin substrate or the like. When glass is used, the glass is preferably non-alkali glass so as to reduce ions eluted from the glass. When soda lime glass is used, a barrier coat such as silica is preferably provided on the soda lime glass. The thickness of the substrate is not particularly limited insofar as it is sufficient for maintaining its mechanical strength. When glass is used, the thickness of the substrate is usually 0.2 mm or larger, preferably 0.7 mm or larger.

Various methods may be used to prepare the anode. For example, ITO film may be formed by an electron beam method, by a sputtering method, by a resistance heating deposition method, by a chemical reaction method (sol/gel method etc.), or by a method of applying a dispersion of indium tin oxide.

By subjecting the anode to washing or any other treatment, the driving voltage of the luminescence element can be lowered, and luminous efficiency can be increased. For example, in the case of ITO, UV-ozone treatment, plasma treatment, or the like are effective.

The cathode supplies electrons to the electron injection layer, electron transport layer, luminescent layer, or the like. The cathode material is selected in consideration of: the adhesion of the cathode to its adjacent layer such as the electron injection layer, the electron transport layer, or the luminescent layer; ionization potential of the cathode material; stability of the cathode material; and the like. As the cathode material, it is possible to use a metal, an alloy, a metal halide, a metal oxide, an electroconductive compound or a mixture thereof, and specific examples of the cathode material include alkali metals (for example, Li, Na, and K) and fluorides or oxides thereof, alkaline earth metals (for example, Mg and Ca) and fluorides or oxides thereof, gold, silver, lead, aluminum, a sodium-potassium alloy or a mixed metal of sodium and potassium, a lithium-aluminum alloy or a mixed metal of lithium and aluminum, a magnesium-silver alloy or a mixed metal of magnesium and silver, and rare earth metals such as indium, ytterbium. The cathode material is preferably a material having a work function of 4 eV or lower, more preferably aluminum, a lithium-aluminum alloy or a mixed metal of lithium and aluminum, or a magnesium-silver alloy or a mixed metal of magnesium and silver. The cathode may have a single-layer structure of the above compound or mixture, or may have a laminated structure comprising compounds selected from the above compounds and mixtures. For example, a laminated structure of aluminum and lithium fluoride or a laminated structure of aluminum and lithium oxide are preferable. The thickness of the cathode can be selected suitably depending on its material, and usually the thickness of the cathode is preferably in the range of 10 nm to 5 μm, more preferably 50 nm to 1 μm, still more preferably 100 nm to 1 μm.

The cathode can be prepared by a method such as an electron beam method, a sputtering method, a resistance heating deposition method, a coating method, or a transfer method. A single metal may be vapor-deposited, or two or more components may be simultaneously vapor-deposited. Further, a plurality of metals can be simultaneously vapor-deposited to form an alloy electrode, or a previously prepared alloy may be vapor-deposited.

A lower sheet resistance of the anode or cathode is more preferred. The sheet resistance of the anode or cathode is preferably several hundreds Ω/sq or lower. The sheet resistance is preferably 500 Ω/sq or lower, more preferably, 300 Ω/sq or lower, particularly preferably, 200 Ω/sq or lower.

The luminescent layer is capable of accepting holes from the anode, or from the hole injection layer, or from the hole transport layer, and is also capable of accepting electrons from the cathode, or from the electron injection layer, or from the electron transport layer. The luminescent layer is further capable of transporting injected charges, and also capable of providing a site for recombination of holes and electrons so as to emit light. The substances included in the luminescent layer are not particularly limited so long as the substances form a layer which satisfy the above requirements for the luminescent layer. Examples of the substances include not only the compounds of the invention but also various metal complexes (such as metal complexes and rare earth complexes of benzoxazole, benzimidazole, benzothiazole, styryl benzene, polyphenyl, diphenyl butadiene, tetraphenyl butadiene, naphthalimide, coumarin, perylene, perinone, oxadiazole, aldazine, pyralizine, cyclopentadiene, bis-styryl anthracene, quinacridone, pyrrolopyridine, thiadiazolopyridine, cyclopentadiene, styryl amine, aromatic dimethylidene compounds and 8-quinolinol), polymer compounds (such as polythiophene, polyphenylene, and polyphenylene vinylene), organic silane, iridium trisphenyl pyridine complex, and transition metal complexes such as platinum porphyrin complex, and derivatives thereof. The thickness of the luminescent layer is not particularly limited, and usually the thickness is preferably in the range of 1 nm to 5 μm, more preferably 5 nm to 1 μm, still more preferably 10 nm to 500 nm.

The method of forming the luminescent layer is not particularly limited, and may be selected from the methods described above as methods for forming the organic compound layer(s). Specifically, methods such as resistance heating deposition, electron beam, sputtering, a molecular accumulation method, a coating method, an ink-jet method, a printing method, an LB method, a transfer method, and the like may be used, among which resistance heating deposition and a coating method are preferable.

The luminescent layer may be formed from a single substance or a plurality of substances. There may be only one luminescent layer or may be a plurality of luminescent layers, and such luminescent layers may emit lights with respectively different colors (for example, white light may be emitted based on the combination of the respective lights). In an embodiment, white light is emitted from a single luminescent layer. When there are a plurality of luminescent layers, the luminescent layers each may be formed by a single substance or a plurality of substances.

The main components of the hole injection layer or hole transport layer are not limited insofar as: the hole injection layer has a function of being injected with holes; and the hole transport layer has a function of transporting holes. The hole injection layer and hole transport layer each may optionally have a function of blocking electrons migrating from the cathode. Specific examples of the main components include: electroconductive high-molecular oligomers of carbazole, triazole, oxazole, oxadiazole, imidazole, polyaryl alkane, pyrazoline, pyrazolone, phenylene diamine, aryl amine, amino-substituted chalcone, styryl anthracene, fluorenone, hydrazone, stilbene, silazane, aromatic tertiary amine compounds, styryl amine compounds, aromatic dimethylidene compounds, porphyrin compounds, polysilane compounds, poly(N-vinyl carbazole), aniline copolymers, thiophene oligomers, polythiophene, and the like; organic silane; carbon films; the compounds of the invention; and derivatives thereof.

The thickness of the hole injection layer or hole transport layer is not particularly limited, and usually the thickness is preferably in the range of 1 nm to 5 μm, more preferably 5 nm to 1 μm, still more preferably 10 nm to 500 nm.

There may be a single hole injection layer comprising at least one of the above substances, or there may be provided two or more hole injection layers each having the same or different composition. Similarly, there may be a single hole transport layer comprising at least one of the above substances, or there may be provided two or more hole transport layers each having the same or different composition.

The method of forming the hole injection layer or the hole transport layer may be a vacuum deposition method, an LB method, a method of applying a solution or dispersion of the hole injection transfer substance in a solvent, an ink-jet method, a printing method, and a transfer method. In the coating method, the substances can be dissolved or dispersed together with a resin component, and examples of the resin component include polyvinyl chloride, polycarbonate, polystyrene, polymethyl methacrylate, polybutyl methacrylate, polyester, polysulfone, polyphenylene oxide, polybutadiene, poly(N-vinyl carbazole), hydrocarbon resin, ketone resin, phenoxy resin, polyamide, ethyl cellulose, vinyl acetate, ABS resin, polyurethane, melamine resin, unsaturated polyester resin, alkyd resin, epoxy resin, and silicon resin.

The main components of the electron injection layer or electron transport layer is not limited insofar as: the electron injection layer has a function of being injected with electrons; and the electron transport layer has a function of transporting electrons. The electron injection layer and electron transport layer each may have a function of blocking holes migrating from the anode. Specific examples of the main components include: various metal complexes such as metal complexes of triazole, oxazole, oxadiazole, imidazole, fluorenone, anthraquinodimethane, anthrone, diphenyl quinone, thiopyran dioxide, carbodiimide, fluorenylidene methane, distyryl pyrazine, aromatic tetracarboxylic acid anhydrides (such as naphthalene tetracarboxylic acid anhydride and perylene tetracarboxylic acid anhydride), phthalocyanine and 8-quinolinol, and metal complexes comprising ligands selected from metal phthalocyanine, benzoxazole, and benzothiazole; organic silane; and derivatives thereof.

As described above, the organic electroluminescence element of the invention preferably comprises an electron transport layer, and the electron transport layer is preferably made of a non-complex compound. While the non-complex compound for constituting the electron transport layer is not particularly restricted, the non-complex compound is preferably a nitrogen-containing heterocyclic compound. Examples of the nitrogen-containing heterocyclic compound are as described above.

The thickness of the electron injection layer or electron transport layer is not particularly limited, but usually the thickness is preferably in the range of 1 nm to 5 μm, more preferably 5 nm to 1 μm, still more preferably 10 nm to 500 nm.

There may be a single electron injection layer comprising at least one of the above substances, or there may be provided two or more electron injection layers each having the same or different composition. Similarly, there may be a single electron transport layer comprising at least one of the above substances, or there may be provided two or more electron transport layers each having the same or different composition.

The method of forming the electron injection layer or the electron transport layer may be a vacuum deposition method, an LB method, a method of applying a solution or dispersion of the electron injection transfer materials in a solvent, an ink-jet method, a printing method, and a transfer method. In the coating method, the materials can be dissolved or dispersed together with a resin component, and the resin component may be selected from the resin components mentioned in the explanation of hole injection layer and hole transport layer.

In an embodiment, a protective layer is provided on the luminescence element. The material of the protective layer is not limited insofar as it has a function of preventing substances (such as water and oxygen) which cause deterioration of the element from entering the element. Specific examples of the protective layer material include metals such as In, Sn, Pb, Au, Cu, Ag, Al, Ti, and Ni, metal oxides such as MgO, SiO, SiO₂, Al₂O₃, GeO, NiO, CaO, BaO, Fe₂O₃, Y₂O₃, and TiO₂, metal fluorides such as MgF₂, LiF, AlF₃, and CaF₂, nitrides such as SiNₓ and SiOₓN_{y}, polyethylene, polypropylene, polymethyl methacrylate, polyimide, polyurea, polytetrafluoroethylene, polychlorotrifluoroethylene, polydichlorodifluoroethylene, a chlorotrifluoroethylene-dichlorodifluoroethylene copolymer, a copolymer obtained by copolymerizing a monomer mixture containing tetrafluoroethylene and at least one kind of comonomer, a fluorine-containing copolymer having a cyclic structure on a main chain of the copolymer, a water-absorbing substance having a water absorption of 1% or higher, and a dampproof substance having a water absorption of 0.1% or lower.

The method of forming the protective layer is not particularly limited. Examples of usable methods include a vacuum deposition method, a sputtering method, a reactive sputtering method, an MBE (molecular beam epitaxy) method, a cluster ion beam method, an ion plating method, a plasma polymerization method (high-frequency excitation ion plating method), a plasma CVD method, a laser CVD method, a thermal CVD method, a gas source CVD method, a coating method, a printing method, and a transfer method.

Applications of the luminescent element of the invention are not particularly limited. The luminescent element of the invention can be used preferably in the fields of display devices, displays, backlight, electrophotography, lighting, recording light sources, exposure light sources, reading light sources, labels, signboards, interiors, optical communication, and the like.

### EXAMPLES

While specific examples of the present invention are described hereinafter, embodiments of the invention are by no means restricted to these examples.

### Comparative Example 1

### Element Described in International Publication No. 01/08230 Pamphlet

A washed ITO substrate was placed in a vapor-deposition apparatus, and TPD (N,N′-diphenyl-N,N′-di(m-natholyl)-benzidine) was vapor-deposited thereon to a thickness of 60 nm. CBP and DCM2 were vapor-deposited thereon to a thickness of 1 nm in a ratio of 99: 1 (ratio by weight). Then, CBP and Ir(ppy)₃ were vapor-deposited thereon to a thickness of 1 nm in a ratio of 90:10. The above two processes of vapor-depositing 1 nm films were alternately repeated 5 times to form an alternately laminated film consisting of 10 films having a thickness of 10 nm in total. BCP was vapor-deposited to a thickness of 20 nm thereon, and Alq was vapor-deposited to a thickness of 30 nm thereon. A patterning mask (such a mask as to give a luminescent area of 4 mm×5 mm) was arranged on this organic film, and magnesium and silver were vapor-deposited to a thickness of 100 nm in a ratio of 25:1 in the vapor-deposition apparatus, and silver was vapor-deposited to a thickness of 50 nm thereon to give an EL element. When the EL element obtained was allowed to emit a light by applying a direct current voltage using Source Major Unit 2400 manufactured by Toyo, Technica Co., red light emission was observed.

The structures of the compounds used in Examples and Comparative Example are shown below.

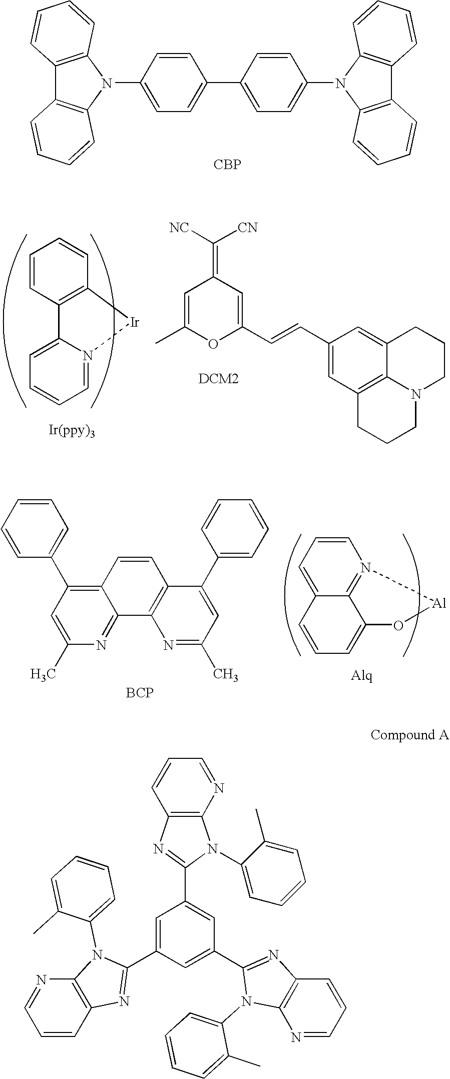

### Example 1

The luminescence element was prepared in the same manner as in Comparative Example 1, except that exemplified compound (1-1) shown above was used in place of DCM2. The obtained luminescence element was evaluated in the same manner as in Comparative Example 1. As a result, yellow light emission was observed and the durability of the luminescence element of Example 1 was about 8 times higher than the durability of the luminescence element of Comparative Example 1, when driven to give emission of 100 cd/m².

### Example 2

The luminescence element was prepared in the same manner as in Comparative Example 1, except that exemplified compound (1-17) shown above was used in place of DCM2. The obtained luminescence element was evaluated in the same manner as in Comparative Example 1. As a result, red light emission was observed and the durability of the luminescence element of Example 2 was about 5 times higher than the durability of the luminescence element of Comparative Example 1, when driven to give emission of 100 cd/m².

### Example 3

The luminescence element was prepared in the same manner as in Comparative Example 1, except that exemplified compound (1-17) shown above was used in place of DCM2 and that the compound A was deposited to a thickness of 50 nm in place of the lamination of BCP and Alq. The obtained luminescence element was evaluated in the same manner as in Comparative Example 1. As a result, red light emission was observed and the durability of the luminescence element of Example 3 was about 5 times higher than the durability of the luminescence element of Comparative Example 1, when driven to give emission of 100 cd/m².

### Example 4

The luminescence element was prepared in the same manner as in Comparative Example 1, except that copper phthalocyanine (10 nm) and α-NPD (N,N′-diphenyl-N,N′-di(α-naphthyl)benzidine; 50 nm) were deposited in place of TPD (60 nm). The obtained luminescence element was evaluated in the same manner as in Comparative Example 1. As a result, yellow light emission was observed and the durability of the luminescence element of Example 3 was about 20 times higher than the durability of the luminescence element of Comparative Example 1, when driven to give emission of 100 cd/m².

The same advantageous effects can be obtained in element using other fluorescent compounds of the invention.

1. An organic electroluminescence element comprising at least one organic compound layer between a pair of electrodes,
wherein the organic compound layer(s) include(s) a luminescent layer;
the luminescent layer comprises a fluorescent compound which emits fluorescent light upon application of voltage;
the luminescent layer further comprises an amplifying agent having a function of amplifying the number of singlet excitons formed upon application of voltage thereby amplifying luminescence intensity upon application of voltage;
an amount of the amplifying agent is such an amount that at least 51% of light components emitted by the element upon the application of voltage is fluorescent light; and
the fluorescent compound has a substituent capable of decreasing an efficiency of Dexter energy transfer from a triplet exciton of the amplifying agent to a triplet exciton of the fluorescent compound.

2. The organic electroluminescence element of claim 1, wherein the substituent capable of decreasing an efficiency of Dexter energy transfer is selected from the group consisting of alkyl groups, aryl groups, heterocyclic groups, alkoxy groups, aryloxy groups, heterocyclyl oxy groups, silyl groups, siloxy groups and amino groups.

3. The organic electroluminescence element of claim 1, wherein a concentration of the fluorescent compound in the luminescent layer is 0.1% to 10% by mass.

4. The organic electroluminescence element of claim 1, wherein the fluorescent compound is a compound represented by formula (1): 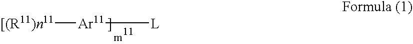
wherein in Formula (1), Ar¹¹ represents an aryl group or a heteroaryl group; R¹¹ represents a substituent; n¹¹ represents an integer of 1 or larger; m¹¹ represents an integer of 2 or larger; and L represents a linking group or a single bond.

5. The organic electroluminescence element of claim 4, wherein in at least one of groups represented by R¹¹ in formula (1), a sum of the number of tertiary carbon atoms and the number of quaternary carbon atoms is 2 to 10.

6. The organic electroluminescence element of claim 4, wherein in at least one of groups represented by R¹¹ in formula (1), the number of tertiary carbon atoms is 2 to 10.

7. The organic electroluminescence element of claim 4, wherein a total number of groups represented by R¹¹ in formula (1) is 3 to 20.

8. The organic electroluminescence element of claim 4, wherein the fluorescent compound is a compound represented by formula (2): 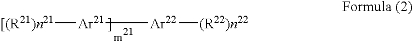
wherein in Formula (2), Ar²¹ represents an aryl group or a heteroaryl group; Ar²² represents an aryl linking group or a heteroaryl linking group; R²¹ and R²² each independently represent a substituent; n²¹ represents an integer of 1 or larger; n²² represents an integer of 0 or larger; and m²¹ represents an integer of 2 or larger.

9. The organic electroluminescence element of claim 8, wherein in at least one of groups each represented by R²¹ or R²² in formula (2), a sum of the number of tertiary carbon atoms and the number of quaternary carbon atoms is 2 to 10.

10. The organic electroluminescence element of claim 8, wherein in at least one of groups each represented by R²¹ or R²² in formula (2), the number of tertiary carbon atoms is 2 to 10.

11. The organic electroluminescence element of claim 8, wherein a total number of groups each represented by R²¹ or R²² in formula (2) is 3 to 20.

12. The organic electroluminescence element of claim 4, wherein the fluorescent compound is a compound represented by formula (3): 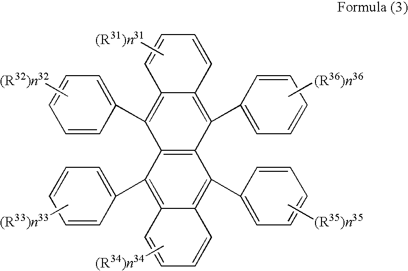
wherein in Formula (3), R³¹ to R³⁶ each independently represent a substituent; n³¹ and n³⁴ each independently represent an integer of 0 to 4; and n³², n³³, n³⁵, and n³⁶ each independently represent an integer of 0 to 5.

13. The organic electroluminescence element of claim 12, wherein in at least one of groups represented by R³¹ to R³⁶ in formula (3), a sum of the number of tertiary carbon atoms and the number of quaternary carbon atoms is 2 to 10.

14. The organic electroluminescence element of claim 12, wherein at least one of groups represented by R³¹ to R³⁶ in formula (3), the number of tertiary carbon atoms is 2 to 10.

15. The organic electroluminescence element of claim 12, wherein a total number of groups represented by R³¹ to R³⁶ in formula (3) is 3 to 20.

16. The organic electroluminescence element of claim 1, wherein at least a part of an emission spectrum of the amplifying agent overlaps an absorption spectrum of the fluorescent compound.

17. An organic electroluminescence element comprising at least one organic compound layer between a pair of electrodes,
wherein the organic compound layer(s) include(s) a luminescent layer;
the luminescent layer comprises a fluorescent compound which emits fluorescent light upon application of voltage;
the luminescent layer further comprises an amplifying agent having a function of amplifying the number of singlet excitons formed upon application of voltage thereby amplifying luminescence intensity upon application of voltage;
an amount of the amplifying agent is such an amount that at least 51% of light components emitted by the element upon the application of voltage is fluorescent light; and
a nucleus of the fluorescent compound is substantially three-dimensionally covered with substituents.

18. The organic electroluminescence element of claim 17, wherein a concentration of the fluorescent compound in the luminescent layer is 0.1% by mass to 10% by mass.

19. An organic electroluminescence element comprising at least one organic compound layer between a pair of electrodes,
wherein the organic compound layer(s) include(s) a luminescent layer;
the luminescent layer comprises a fluorescent compound which emits fluorescent light upon application of voltage;
the luminescent layer further comprises an amplifying agent having a function of amplifying the number of singlet excitons formed upon application of voltage thereby amplifying luminescence intensity upon application of voltage;
an amount of the amplifying agent is such an amount that at least 51% of light components emitted by the element upon the application of voltage is fluorescent light; and
the fluorescent compound has a substituent capable of decreasing an efficiency of electron transfer from adjoining molecules to the fluorescent compound.

20. The organic electroluminescence element of claim 19, wherein the substituent capable of decreasing an efficiency of Dexter energy transfer is selected from the group consisting of alkyl groups, aryl groups, heterocyclic groups, alkoxy groups, aryloxy groups, heterocyclyl oxy groups, silyl groups, siloxy groups and amino groups.
